(19) United States
(12) Patent Application Publication
(10) Pub. No.: US 2019/0166315 A1
(43) Pub. Date: May 30, 2019

(54) IMAGE READING DEVICE AND NON-TRANSITORY RECORDING MEDIUM RECORDED WITH IMAGE READING PROGRAM

(71) Applicant: KYOCERA Document Solutions Inc., Osaka (JP)

(72) Inventor: Hideki Ito, Osaka (JP)

(21) Appl. No.: 16/174,595

(22) Filed: Oct. 30, 2018

(30) Foreign Application Priority Data
Nov. 24, 2017 (JP) 2017-225473

(51) Int. Cl. H04N 5/265; H04N 5/235; G06T 7/13; G06K 9/00

(52) U.S. Cl. CPC H04N 5/265; H04N 5/2351; G06T 7/13; G06K 9/00442; G06T 7/33; G06T 2207/30176; G06K 2209/01; G06T 2207/20221; G06T 2207/10016; G06K 9/00744

(57) ABSTRACT

An image reading device includes a camera, an acquisition processing portion, a still image extraction processing portion, and a combining processing portion. The acquisition processing portion acquires data of a moving image photographed by the camera. The still image extraction processing portion extracts a plurality of pieces of still image data from the data of the moving image. The combining processing portion generates composite image data by combining the plurality of pieces of still image data such that common parts of a subject included in two arbitrary pieces of still image data among the plurality of pieces of still image data overlap each other at least in part.

### INCORPORATION BY REFERENCE

This application is based upon and claims the benefit of priority from the corresponding Japanese Patent Application No. 2017-225473 filed on Nov. 24, 2017, the entire contents of which are incorporated herein by reference.

### BACKGROUND

The present disclosure relates to an image reading device and a non-transitory recording medium recorded with an image reading program.

There is known a mobile information terminal capable of generating a composite image that does not give a sense of incongruity, from a plurality of images photographed by a plurality of the mobile information terminals which each have a communication function and an electronic photographing function.

### SUMMARY

An image reading device according to an aspect of the present disclosure includes a camera, an acquisition processing portion, a still image extraction processing portion, and a combining processing portion. The acquisition processing portion acquires data of a moving image photographed by the camera. The still image extraction processing portion extracts a plurality of pieces of still image data from the data of the moving image. The combining processing portion generates composite image data by combining the plurality of pieces of still image data such that common parts of a subject included in two arbitrary pieces of still image data among the plurality of pieces of still image data overlap each other at least in part.

A recording medium according to another aspect of the present disclosure is a non-transitory computer-readable recording medium recorded with an image reading program that causes a processor of a mobile information processing apparatus equipped with a camera to execute an acquisition step, an extraction step, and a combining step. In the acquisition step, data of a moving image photographed by the camera is acquired. In the extraction step, a plurality of pieces of still image data are extracted from the data of the moving image. In the combining step, composite image data is generated by combining the plurality of pieces of still image data such that common parts of a subject included in two arbitrary pieces of still image data among the plurality of pieces of still image data overlap each other at least in part.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram showing a system configuration of an image reading device according to an embodiment of the present disclosure.

FIG. 2 is a diagram showing an example of how to move the image reading device according to the embodiment of the present disclosure when photographing a moving image of a subject with a camera of the image reading device.

FIG. 3 is a flowchart showing an example of a procedure of an image reading process executed in the image reading device according to the embodiment of the present disclosure.

FIG. 4 is a diagram showing an example of a method of extracting still image data from moving image data in the image reading device according to the embodiment of the present disclosure.

FIG. 5 is a diagram showing an example of a method of generating composite image data in the image reading device according to the embodiment of the present disclosure.

FIG. 6 is a diagram showing an example of a method of generating composite image data in the image reading device according to the embodiment of the present disclosure.

FIG. 7 is a diagram showing an example of a method of removing a reflection of a light source in an image photographed by the camera.

FIG. 8 is a diagram showing an example of still image data extracted from moving image data photographed by the camera of the image reading device according to the embodiment of the present disclosure.

FIG. 9 is a diagram showing an example of the composite image data finally generated in the image reading device according to the embodiment of the present disclosure.

FIG. 10 is a diagram showing an example of document image data extracted from the composite image data finally generated in the image reading device according to the embodiment of the present disclosure.

### DETAILED DESCRIPTION

The following describes an embodiment of the present disclosure with reference to the accompanying drawings for the understanding of the present disclosure. It should be noted that the following embodiment is an example of a specific embodiment of the present disclosure and should not limit the technical scope of the present disclosure.

[Image Reading Device]

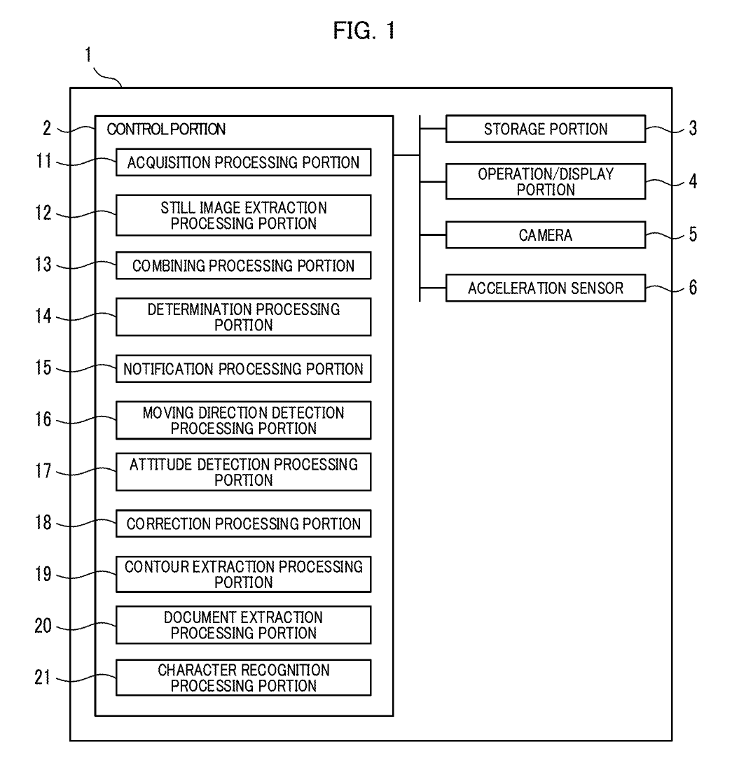

As shown in FIG. 1, an image reading device 1 includes a control portion 2, a storage portion 3, an operation/display portion 4, a camera 5, and an acceleration sensor 6. The image reading device 1 is a hand-held information processing apparatus such as a smartphone or a tablet terminal.

The control portion 2 includes control equipment such as a CPU, a ROM, and a RAM. The CPU is a processor that executes various calculation processes. The ROM is a non-volatile storage in which control programs such as BIOS and OS for causing the CPU to execute various processes, are stored in advance. The RAM is a volatile or non-volatile storage configured to store various information, and is used as a temporary storage memory (working area) for the various processes executed by the CPU. The control portion 2 controls the image reading device 1 by causing the CPU to execute the various control programs stored in advance in the ROM or the storage portion 3.

The storage portion 3 is a non-volatile storage such as a flash memory configured to store various information. For example, control programs such as an image reading program are stored in the storage portion 3. The image reading program is a control program for causing the control portion 2 to execute a process of reading an image of a subject based on digital image data output from the camera 5. The image reading program is recorded on a computer-readable non-transitory recording medium such as a CD or a DVD in a non-transitory manner, and is stored into the storage portion 3 from the recording medium.

The operation/display portion 4 is a user interface including a display portion and an operation portion, wherein the display portion is, for example, a liquid crystal display or an organic EL display and configured to display various information, and the operation portion is, for example, a touch panel or a set of hard keys and configured to receive operations.

The camera 5 includes a lens and an imaging element, and outputs digital image data in response to light incident on the imaging element. The digital image data output from the camera 5 is stored in the RAM or the storage portion 3 as moving image data or still image data depending on the photographing mode.

The acceleration sensor 6 is used to detect, for example, a moving direction of the image reading device 1 and an attitude (tilt) thereof in a stationary state.

There is known a mobile information terminal capable of generating a composite image that does not give a sense of incongruity, from a plurality of images photographed by a plurality of the mobile information terminals which each have a communication function and an electronic photographing function. Meanwhile, in a case where a large document such as a newspaper or a poster is photographed in one shot so that the whole of it is included in the photographing range, the characters of the document in the photographed image data are too small to see. One may consider that the problem will be solved by applying the above-mentioned technology so that a plurality of the mobile information terminals photograph different parts of the document, and a composite image of the whole document is generated by combining a plurality of photographed images. However, in that case, it is necessary to prepare a plurality of mobile information terminals. In addition, the plurality of mobile information terminals need to be operated by a plurality of users. On the other hand, according to the image reading device 1 of the present embodiment, it is possible to read an image of a large subject easily.

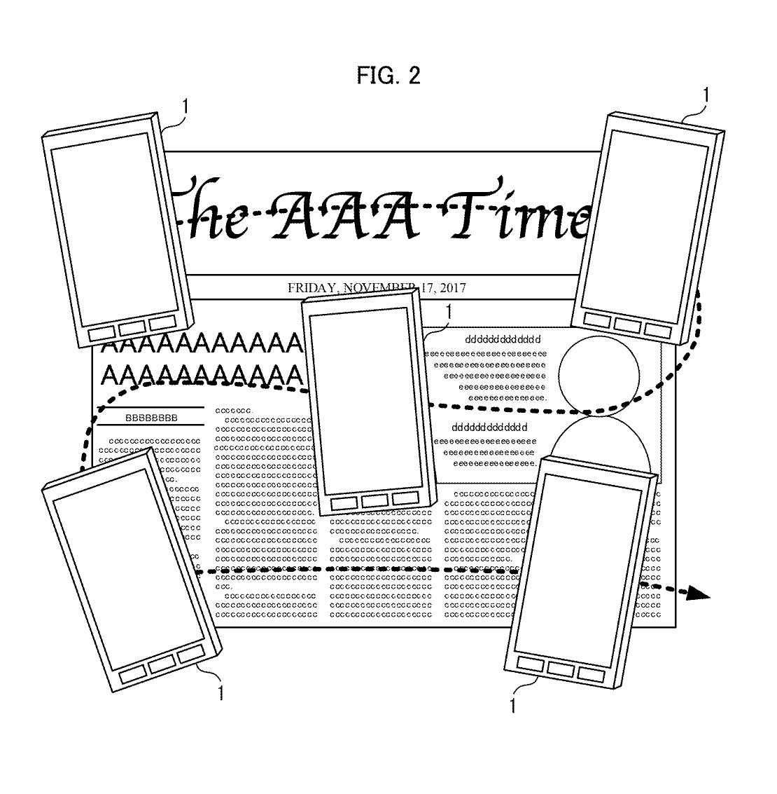

In the image reading device 1 according to the present embodiment, it is possible to read an image of a large document such as a newspaper or a poster based on data of a moving image photographed by the camera 5. To read an image of a large document, the user photographs a moving image of the document (the subject) by moving the image reading device 1 on the document at such a distance that enables characters in the document to be read clearly from the image photographed by the camera 5, in a direction approximately parallel to the document (for example, in an up-down direction, a left-right direction, or a zig-zag direction with respect to the plane surface of the document) (see FIG. 2). In the image reading device 1, an image of the whole document is generated based on the data of the moving image acquired in this way.

Specifically, the control portion 2 includes an acquisition processing portion 11, a still image extraction processing portion 12, a combining processing portion 13, a determination processing portion 14, a notification processing portion 15, a moving direction detection processing portion 16, an attitude detection processing portion 17, a correction processing portion 18, a contour extraction processing portion 19, a document extraction processing portion 20, and a character recognition processing portion 21. It is noted that the control portion 2 functions as these processing portions when it executes various processes in accordance with the image reading program. In addition, the control portion 2 may include an electronic circuit that realizes a part of these processing portions or a plurality of processing functions.

The acquisition processing portion 11 acquires data of a moving image photographed by the camera 5. For example, the acquisition processing portion 11 acquires, as the moving image data, a series of pieces of digital image data that are output in sequence from the camera 5. Alternatively, the acquisition processing portion 11 acquires, from the storage portion 3, moving image data that had been output from the camera 5 and stored in the storage portion 3.

The still image extraction processing portion 12 extracts a plurality of pieces of still image data from the moving image data acquired by the acquisition processing portion 11. For example, the still image extraction processing portion 12 extracts frame images as a plurality of pieces of still image data at a rate of one frame image for every predetermined number of (for example, 10) frame images, from a series of frame images (a series of pieces of still image data) that constitute the moving image data.

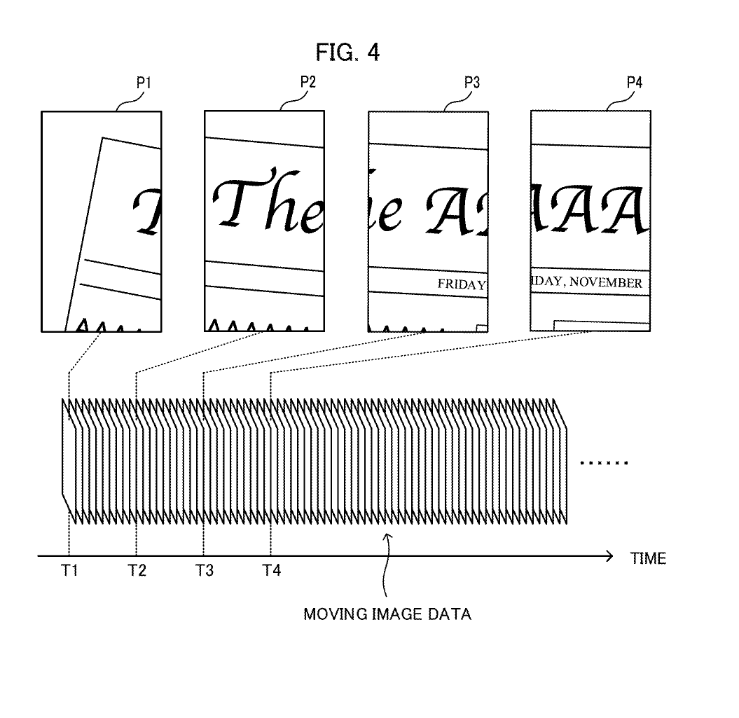

For example, as shown in FIG. 4, the still image extraction processing portion 12 extracts a plurality of pieces of still image data P1, P2, P3, P4, . . . in sequence in time series from the moving image data acquired by the acquisition processing portion 11. In the example shown in FIG. 4, a plurality of pieces of still image data are extracted from the moving image data at a rate of one per 10 frames.

It is noted that the still image extraction processing portion 12 may change the number of frame images to be extracted from the moving image data per unit time (photographing time), based on the moving speed of the image reading device 1 during the photographing. For example, the number of frame images to be extracted from the moving image data per unit time in the photographing may be increased as the moving speed of the image reading device 1 during the photographing increases. It is noted that the moving speed of the image reading device 1 during the photographing may be calculated based on the output signal that is output from the acceleration sensor 6 during the photographing.

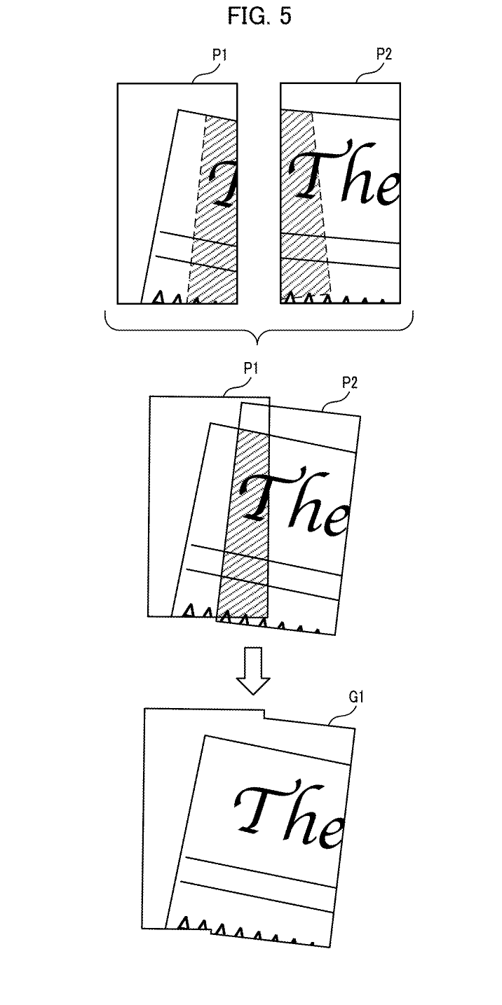

The combining processing portion 13 generates composite image data G1 (see FIG. 5) by combining the plurality of pieces of still image data such that common parts of a subject (for example, slanted-line portions shown in FIG. 5) included in two arbitrary pieces of still image data among the plurality of pieces of still image data overlap each other at least in part. It is noted that any known detection method may be adopted as the method for detecting the common parts of the subject included in the two pieces of still image data. For example, the similarity between overlapping parts of the two pieces of still image data may be calculated while gradually changing the relative position and relative angle of the two pieces of still image data, and the common parts may be detected based on the calculated values of the similarity.

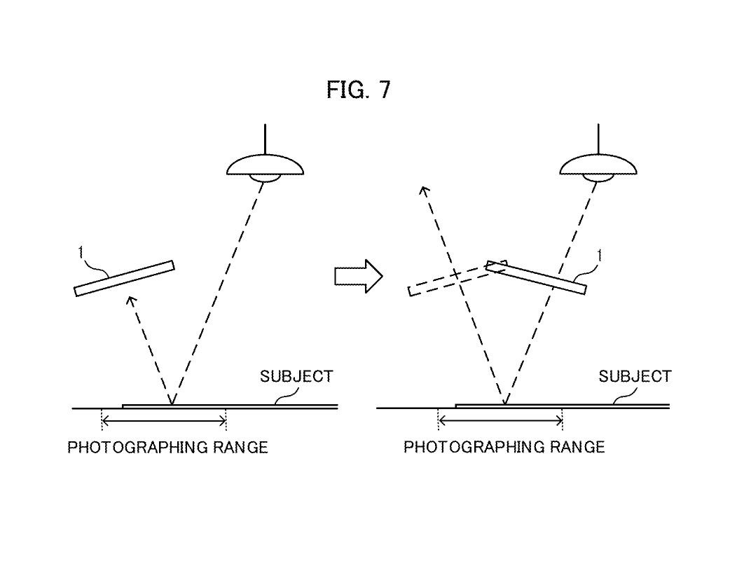

Meanwhile, when, in particular, a shiny subject is photographed by the camera 5, light from a light source may be reflected on the subject as shown in the left part of FIG. 7, and a reflection of the light source may be included in the photographed image. As shown in the right part of FIG. 7, such reflection of the light source may be avoided by changing the photographing direction of the camera 5 with respect to the subject.

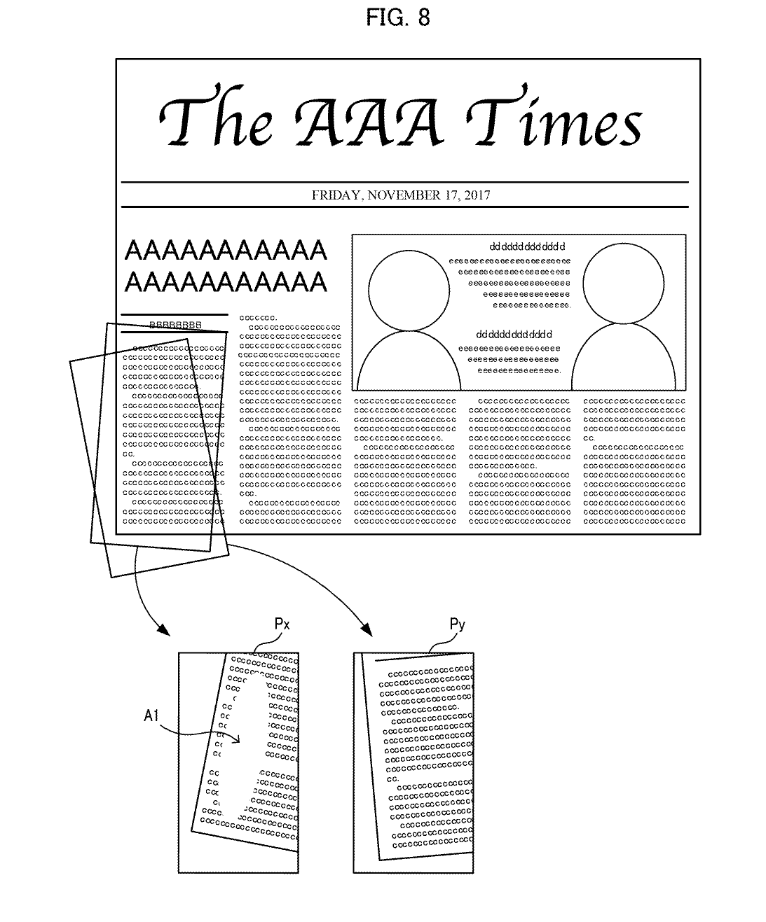

The determination processing portion 14 determines whether or not the still image data extracted by the still image extraction processing portion 12 includes a light reflection area A1 (see FIG. 8), wherein the light reflection area A1 is an area having a reflection of light from the light source. For example, the determination processing portion 14 determines that the still image data includes the light reflection area A1 when it includes an area composed of a predetermined number of pixels or more whose luminance is equal to or higher than a predetermined threshold.

The light reflection area A1 in the still image data is white due to reflection of light from the light source, and the characters in the light reflection area A1 are indistinguishable. As a result, when the determination processing portion 14 determines that a piece of still image data (for example, still image data Px shown in FIG. 8) includes the light reflection area A1, the combining processing portion 13 generates the composite image data G1 by using another piece of still image data (for example, still image data Py shown in FIG. 8) that includes a portion of the subject corresponding to the light reflection area A1, instead of the piece of still image data including the light reflection area A1. This makes it possible to generate the composite image data G1 that does not include the light reflection area A1.

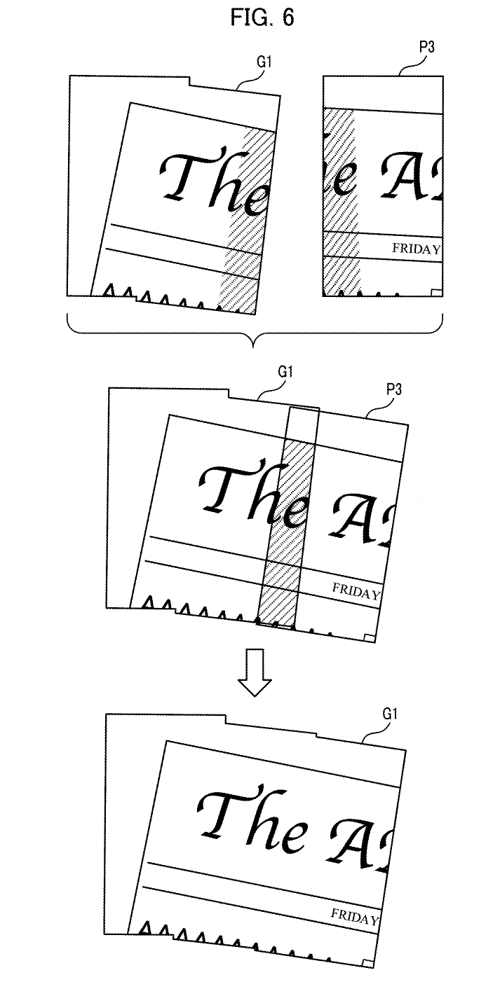

For example, in a case where the still image extraction processing portion 12 extracts a plurality of pieces of still image data in sequence in time series from the moving image data, the combining processing portion 13 first generates the composite image data G1 by combining two pieces of still image data that have been extracted first and second (for example, still image data P1 and still image data P2 shown in FIG. 4) by the still image extraction processing portion 12 (see FIG. 5). Furthermore, the combining processing portion 13 combines the composite image data G1 with each piece of still image data extracted by the still image extraction processing portion 12 third and onward in sequence (for example, still image data P3, P4, . . . shown in FIG. 4) (see FIG. 6). During this process, the combining processing portion 13 at least skips combining the light reflection area A1 with the composite image data G1. This makes it possible to generate the composite image data G1 that does not include the light reflection area A1.

The notification processing portion 15 notifies a predetermined message when the determination processing portion 14 determines that the still image data includes the light reflection area A1, during a photographing of the subject with the camera 5. For example, the message urges to re-photograph a portion of the subject that corresponds to the light reflection area A1, from a different photographing direction with respect to the subject. In response to the message, the user re-photographs a portion of the subject corresponding to the light reflection area A1 with the camera 5 from a different photographing direction with respect to the subject. As a result, still image data including the portion of the subject corresponding to the light reflection area A1 is obtained. This makes it possible to generate the composite image data G1 without the light reflection area A1.

The moving direction detection processing portion 16 detects the moving direction of the image reading device 1. Specifically, the moving direction detection processing portion 16 detects the moving direction of the image reading device 1 based on the output signal of the acceleration sensor 6. It is noted that the moving direction detection processing portion 16 may detect the moving direction of the image reading device 1 by a different method. For example, it may detect the moving direction of the image reading device 1 based on an amount of positional change of the subject between frame images in the moving image data photographed by the camera 5.

The combining processing portion 13 may generate the composite image data G1 by arranging the plurality of pieces of still image data based on the moving direction of the image reading device 1 detected by the moving direction detection processing portion 16 during a photographing of the subject with the camera 5.

The attitude detection processing portion 17 detects an attitude of the image reading device 1 (namely, the photographing direction of the camera 5) Specifically, the attitude detection processing portion 17 detects the attitude of the image reading device 1 based on the output signal of the acceleration sensor 6. It is noted that the attitude detection processing portion 17 may detect the attitude of the image reading device 1 by a different method. For example, it may detect the attitude of the image reading device 1 based on an output signal of a gyro sensor.

The correction processing portion 18 corrects the still image data extracted by the still image extraction processing portion 12 based on the attitude of the image reading device 1 that is detected by the attitude detection processing portion 17 during the photographing of the subject with the camera 5. For example, when a rectangular area included in a document such as a newspaper is photographed from an oblique direction by the camera 5, the rectangular area will be distorted into a trapezoidal shape in the still image data. Not only rectangular areas, but also characters will be distorted in a similar manner. In view of this, the correction processing portion 18 may be configured to perform a trapezoidal shape correcting process (a process for correcting distorted trapezoidal-shape images) on the still image data extracted by the still image extraction processing portion 12, based on the attitude (or a change of the attitude) of the image reading device 1 detected by the attitude detection processing portion 17 during the photographing of the subject with the camera 5. This makes it possible to suppress the composite image data G1 from including a distorted image.

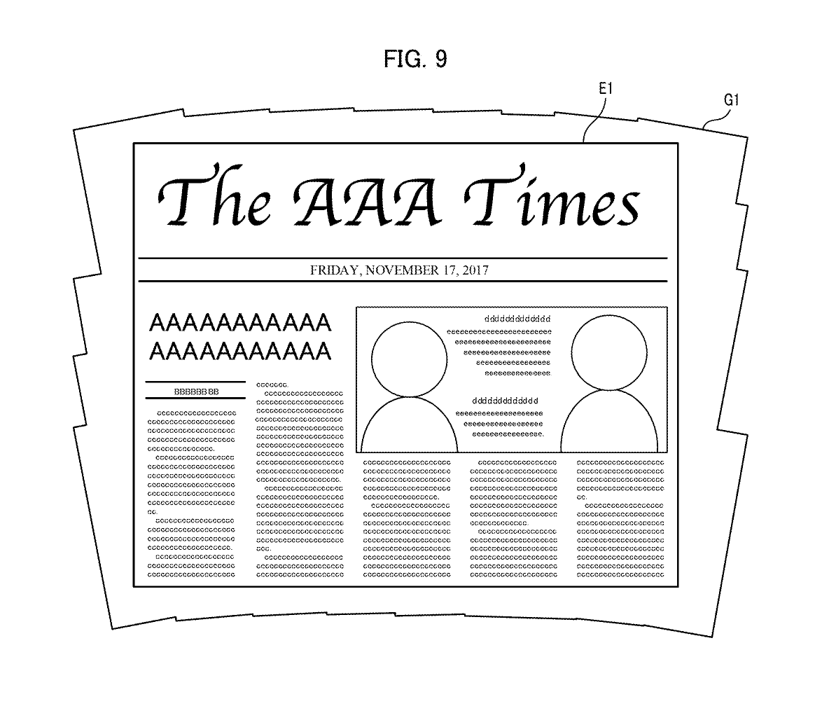

The contour extraction processing portion 19 extracts a contour E1 of the document (see FIG. 9) from the composite image data G1 finally generated by the combining processing portion 13. For example, the contour extraction processing portion 19 may perform an edge extracting process for detecting and extracting a rectangular edge included in the finally generated composite image data G1 as the contour E1 of the document.

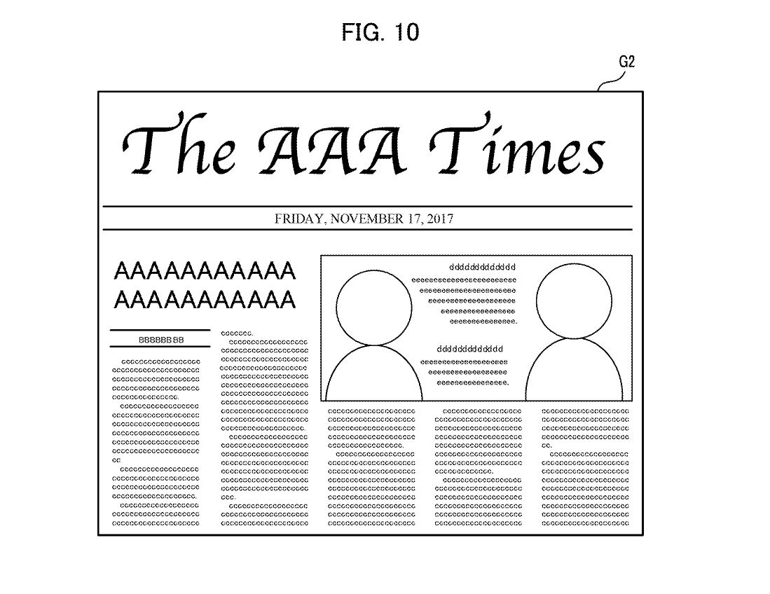

The document extraction processing portion 20 extracts image data surrounded by the contour E1 that has been extracted by the contour extraction processing portion 19, from the composite image data G1 finally generated by the combining processing portion 13. Specifically, the document extraction processing portion 20 extracts, as document image data G2 (see FIG. 10), image data surrounded by the contour E1 extracted by the contour extraction processing portion 19 by performing clipping processing on the finally generated composite image data G1.

The character recognition processing portion 21 performs a character recognition process on the plurality of pieces of still image data extracted by the still image extraction processing portion 12. The combining processing portion 13 may generate the composite image data G1 based on one or more characters included in the plurality of pieces of still image data as a result of the character recognition process. For example, the combining processing portion 13 may identify a common part of the subject included in two arbitrary pieces of still image data among the plurality of pieces of still image data based on the result of the character recognition process performed by the character recognition processing portion 21.

[Image Reading Process]

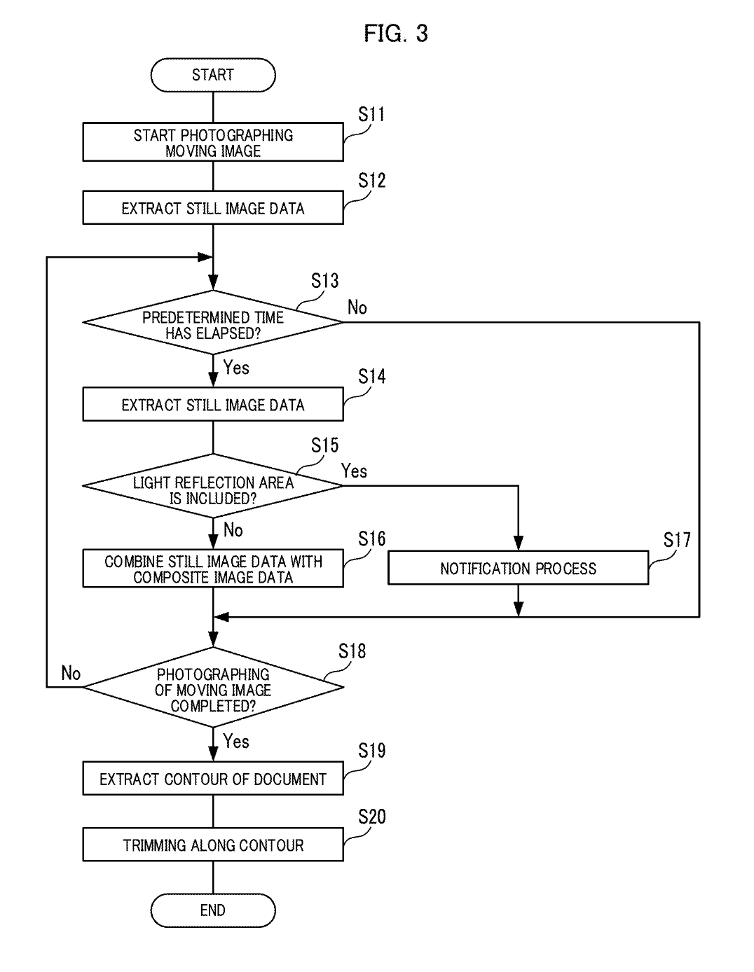

In the following, with reference to FIG. 3, a description is given of an example of the procedure of the image reading process executed by the control portion 2. Here, steps S11, S12, . . . represent numbers assigned to the processing procedures (steps) executed by the control portion 2. It is noted that the image reading process starts in response to an execution of a predetermined image reading start operation (for example, a pressing of an image reading start button displayed on the operation/display portion 4).

<Step S11>

First, in step S11, the control portion 2 causes the camera 5 to start photographing a moving image. This allows moving image data to be output from the camera 5. FIG. 4 shows moving image data (namely, a plurality of frame images) that has been output from the camera 5 after the photographing started at time T1. The process of the step S11 is executed by the acquisition processing portion 11 of the control portion 2. It is noted that the control portion 2 may display the moving image photographed by the camera 5 in real time on the operation/display portion 4 while the moving image is photographed by the camera 5.

<Step S12>

In step S12, the control portion 2 extracts a piece of still image data from the moving image data output from the camera 5. For example, the control portion 2 extracts, as the piece of still image data, the first frame image from the moving image data (see the still image data P1 shown in FIG. 4). The process of the step S12 is executed by the still image extraction processing portion 12 of the control portion 2.

<Step S13>

In step S13, the control portion 2 determines whether or not a predetermined time (for example, 333 ms) has elapsed since the extraction of the piece of still image data in the step S12 or step S14 that is described below. When it is determined that the predetermined time has elapsed (S13: Yes), the process moves to step S14. On the other hand, when it is determined that the predetermined time has not elapsed (S13: No), the process moves to step S18.

<Step S14>

In step S14, the control portion 2 extracts a piece of still image data from the moving image data output from the camera 5. For example, the control portion 2 extracts the latest frame image from the moving image data, as the piece of still image data. Each time the steps S13 and S14 are executed, a piece of still image data is extracted at a predetermined time interval, and when the steps S13 and S14 have been repeated a plurality of times, a plurality of pieces of still image data (the still image data P1, P2, P3, P4, . . . shown in FIG. 4) have been extracted from the moving image data output from the camera 5. The process of the step S14 is executed by the still image extraction processing portion 12 of the control portion 2.

It is noted that the control portion 2 (the correction processing portion 18) may perform, as necessary, the trapezoidal shape correcting process on the piece of still image data extracted in the step S14. In addition, the control portion 2 may perform, as necessary, arbitrary image processing such as an expansion/contraction process and a sharpening process on the piece of still image data extracted in the step S14.

<Step S15>

In step S15, the control portion 2 determines whether or not the light reflection area A1 (see FIG. 8) is included in the piece of still image data extracted in the step S14. When it is determined that the light reflection area A1 is included in the piece of still image data (S15: Yes), the process moves to step S17. On the other hand, when it is determined that the light reflection area A1 is not included in the piece of still image data (S15: No), the process moves to step S16. The process of the step S15 is executed by the determination processing portion 14 of the control portion 2.

<Step S16>

In step S16, the control portion 2 combines the piece of still image data extracted in the step S14, with the composite image data G1. It is noted that in case the composite image data G1 has not been generated yet, the control portion 2 generates the composite image data G1 by combining the still image data P1 extracted in the step S12 with still image data P2 extracted in the step S14, as shown in FIG. 5. On the other hand, in case the composite image data G1 has already been generated, the control portion 2 combines the composite image data G1 with the piece of still image data (for example, still image data P3) extracted in the step S14, as shown in FIG. 6. Each time the composite image data G1 is combined with a piece of still image data in this way, the composite image data G1 becomes larger. The process of the step S16 is executed by the combining processing portion 13 of the control portion 2. Thereafter, the process moves to step S18.

It is noted that in the step S16, the control portion 2 may detect the moving direction of the image reading device 1, and combine the piece of still image data extracted in the step S14 with the composite image data G1 based on the detected moving direction.

In addition, the control portion 2 (the character recognition processing portion 21) may perform the character recognition process on the piece of still image data extracted in the step S14. Furthermore, in the step S16, the control portion 2 may identify a common part of the subject included in two arbitrary pieces of still image data based on the result of the character recognition process.

<Step S17>

On the other hand, in step S17, the control portion 2 performs a notification process. For example, the control portion 2 displays on the operation/display portion 4 a message that urges to re-photograph, with the camera 5, a portion of the subject that corresponds to the light reflection area A1, from a different photographing direction with respect to the subject. For example, the control portion 2 displays on the operation/display portion 4 a message: “A reflection of light from a light source is included in the current photographing range. Please photograph the same photographing range again from a different angle so that a reflection of light is not included in the photograph”. In response to the message, the user moves the image reading device 1 from a position shown in the left portion in FIG. 7 to a position shown in the right portion in FIG. 7 while continuing the photographing of the moving image with the camera 5, and re-photographs the portion of the subject corresponding to the light reflection area A1. With this configuration, even if the light reflection area A1 is included in a piece of still image data as is the case with the still image data Px shown in FIG. 8, another piece of still image data such as the still image data Py shown in FIG. 8 is obtained by re-photographing the portion of the subject corresponding to the light reflection area A1, and the newly obtained piece of still image data is combined with the composite image data G1. The process of the step S17 is executed by the notification processing portion 15 of the control portion 2.

It is noted that in the present embodiment, when it is determined in the step S15 that the light reflection area A1 is included in a piece of still image data, the piece of still image data is not combined with the composite image data G1. However, as another embodiment, when it is determined in the step S15 that the light reflection area A1 is included in a piece of still image data, an area other than the light reflection area in the piece of still image data may be combined with the composite image data G1.

<Step S18>

In step S18, the control portion 2 determines whether or not the photographing of the moving image with the camera 5 has been completed. For example, the control portion 2 determines that the photographing of the moving image has been completed when a predetermined photographing end operation has been executed (for example, a photographing end button displayed on the operation/display portion 4 has been pressed). When it is determined that the photographing of the moving image has been completed (S18: Yes), the process moves to step S19. On the other hand, when it is determined that the photographing of the moving image has not been completed (S18: No), the process returns to step S13.

<Step S19>

In step S19, the control portion 2 extracts the contour E1 (see FIG. 9) of the document from the finally generated composite image data G1. The process of the step S19 is executed by the contour extraction processing portion 19 of the control portion 2.

<Step S20>

In step S20, the control portion 2 trims the composite image data G1 along the contour E1 extracted in the step S19. This allows the document image data G2, as shown in FIG. 10, to be extracted from the composite image data G1. The process of the step S20 is executed by the document extraction processing portion 20 of the control portion 2. Thereafter, the image reading process ends.

It is noted that the control portion 2 may perform the character recognition process on the document image data G2 extracted in the step S20, and store, in the storage portion 3, text data indicating character sequences that were extracted from the document image data G2 during the character recognition process.

It is noted that in a case where images are read from a subject such as a newspaper or a book that includes a plurality of pages, the user may perform a predetermined page change operation (for example, press a page change button displayed on the operation/display portion 4) each time a photographing of a page of moving image is completed. In addition, each time the page change operation is performed, the control portion 2 may store the composite image data G1 at that time in the storage portion 3 in association with a page number of the photographed page, and start generating new composite image data G1 that corresponds to the next page.

As described above, in the image reading device 1 according to the present embodiment, the composite image data G1 is generated based on a plurality of pieces of still image data extracted from data of moving image photographed by the camera 5. As a result, the image reading device 1 of the present embodiment can easily read an image of a large subject such as a newspaper or a poster only by photographing a moving image of the subject with the camera 5.

In addition, in the image reading device 1 according to the present embodiment, even if the light reflection area A1 is included in a piece of still image data extracted from the moving image data photographed by the camera 5, the composite image data G1 is generated based on another piece of still image data including a portion of the subject corresponding to the light reflection area A1 photographed from a different direction. As a result, according to the image reading device 1 of the present embodiment, it is possible to generate the composite image data G1 that does not include the light reflection area A1.

In addition, the image reading device 1 of the present embodiment can read an image of a subject by photographing a moving image of the subject with the camera 5 while the image reading device 1 is moved in an arbitrary direction. As a result, the image reading device 1 can read an image not only from a flat-surface subject such as a newspaper placed on a desk, but also from an uneven subject such as a label sticked on a bottle.

[Modifications]

The present embodiment describes a case of reading an image of a newspaper. However, not limited to reading an image of a newspaper, the present disclosure is applicable to reading an image of an arbitrary document. Furthermore, not limited to reading a document, the present disclosure is applicable to reading an image of an arbitrary subject such as a painting or a poster.

In addition, in the present embodiment, a description is given of a case where photographing a moving image with the camera 5 and generating the composite image data G1 based on still image data extracted from the moving image are performed in parallel. However, the present disclosure is not limited to the configuration. As another embodiment, after a photographing of a moving image with the camera 5 is completed, a plurality of pieces of still image data may be generated from the moving image, and the composite image data G1 may be generated based on the plurality of pieces of still image data.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image reading device comprising:
a camera;
an acquisition processing portion configured to acquire data of a moving image photographed by the camera;
a still image extraction processing portion configured to extract a plurality of pieces of still image data from the data of the moving image; and
a combining processing portion configured to generate composite image data by combining the plurality of pieces of still image data such that common parts of a subject included in two arbitrary pieces of still image data among the plurality of pieces of still image data overlap each other at least in part.

2. The image reading device according to claim 1, further comprising:
a determination processing portion configured to determine whether or not the plurality of pieces of still image data extracted by the still image extraction processing portion include a light reflection area that is an area having a reflection of light from a light source, wherein
when the determination processing portion determines that a piece of still image data includes the light reflection area, the combining processing portion generates the composite image data by using another piece of still image data that includes a portion of the subject corresponding to the light reflection area, instead of the piece of still image data including the light reflection area.

3. The image reading device according to claim 2, wherein
the still image extraction processing portion extracts the plurality of pieces of still image data in sequence in time series from the moving image data,
the combining processing portion first generates the composite image data by combining two pieces of still image data that have been extracted first and second by the still image extraction processing portion, and combines the composite image data with each piece of still image data extracted by the still image extraction processing portion third and onward in sequence, and
when the determination processing portion determines that the piece of still image data includes the light reflection area, the combining processing portion at least skips combining the light reflection area with the composite image data.

4. The image reading device according to claim 2, further comprising:
a notification processing portion configured to notify a predetermined message when the determination processing portion determines that the piece of still image data includes the light reflection area, during a photographing of the subject with the camera.

5. The image reading device according to claim 4, wherein
the message urges to re-photograph a portion of the subject that corresponds to the light reflection area, from a different photographing direction with respect to the subject.

6. The image reading device according to claim 1, further comprising:
a moving direction detection processing portion configured to detect a moving direction of the image reading device, wherein
the combining processing portion generates the composite image data by arranging the plurality of pieces of still image data based on the moving direction of the image reading device detected by the moving direction detection processing portion during a photographing of the subject with the camera.

7. The image reading device according to claim 1, further comprising:
an attitude detection processing portion configured to detect an attitude of the image reading device; and
a correction processing portion configured to correct the plurality of pieces of still image data extracted by the still image extraction processing portion based on the attitude of the image reading device detected by the attitude detection processing portion during a photographing of the subject with the camera.

8. The image reading device according to claim 1, wherein
the subject is a document, the image reading device further comprising:
a contour extraction processing portion configured to extract a contour of the document from the composite image data finally generated by the combining processing portion; and
a document extraction processing portion configured to extract image data surrounded by the contour extracted by the contour extraction processing portion, from the composite image data finally generated by the combining processing portion.

9. The image reading device according to claim 1, further comprising:
a character recognition processing portion configured to perform a character recognition process on the plurality of pieces of still image data, wherein
the combining processing portion generates the composite image data based on one or more characters included in the plurality of pieces of still image data as a result of the character recognition process.

10. A non-transitory computer-readable recording medium recorded with an image reading program that causes a processor of a mobile information processing apparatus equipped with a camera to execute:
an acquisition step of acquiring data of a moving image photographed by the camera;
an extraction step of extracting a plurality of pieces of still image data from the data of the moving image; and
a combining step of generating composite image data by combining the plurality of pieces of still image data such that common parts of a subject included in two arbitrary pieces of still image data among the plurality of pieces of still image data overlap each other at least in part.
